(19) United States
(12) Patent Application Publication
(10) Pub. No.: US 2014/0347727 A1
(43) Pub. Date: Nov. 27, 2014

(54) OPTICAL FILM WITH ADHESIVE LAYER, AND IMAGE DISPLAY DEVICE

(71) Applicant: NITTO DENKO CORPORATION, Ibaraki-shi, Osaka (JP)

(72) Inventors: Kunihiro Inui, Ibaraki-shi (JP); Takaaki Ishii, Ibaraki-shi (JP); Kazuki Murayama, Ibaraki-shi (JP); Toshitsugu Hosokawa, Ibaraki-shi (JP); Masayuki Satake, Ibaraki-shi (JP)

(73) Assignee: NITTO DENKO CORPORATION, Ibaraki-shi, Osaka (JP)

(21) Appl. No.: 14/368,448

(22) PCT Filed: Jan. 8, 2013
(86) PCT No.: PCT/JP2013/050119

§ 371 Date: Jun. 24, 2014

(30) Foreign Application Priority Data
Jan. 19, 2012 (JP) 2012-009214

(51) Int. Cl. G02B 1/10; C09J 7/02; G02B 5/30

(52) U.S. Cl. CPC G02B 1/105; G02B 5/3025; C09J 7/0217; C09J 2429/006
USPC 359/483.01

(57) ABSTRACT

A pressure-sensitive adhesive layer-attached optical film of the present invention comprises an optical film; and a pressure-sensitive adhesive layer and made from an ammonia-containing water-dispersible pressure-sensitive adhesive, wherein the pressure-sensitive adhesive layer has an ammonia content of 10 to 500 μg per 1 g of the pressure-sensitive adhesive layer, and shows a difference of 0 to 500 μg per 1 g of the pressure-sensitive adhesive layer in ammonia content before and after a heat durability test and humidity durability test, and the optical film includes a polarizing film with a degree of polarization of 99.99% or more. The pressure-sensitive adhesive layer-attached optical film has optical properties which are less changeable even in a high-temperature and/or high-humidity environment.

### TECHNICAL FIELD

The present invention relates to a pressure-sensitive adhesive layer-attached optical film including an optical film and the pressure-sensitive adhesive layer provided thereon. The present invention also relates to an image display device such as a liquid crystal display device, an organic electroluminescence (EL) display device, a cathode-ray tube (CRT), or a plasma display panel (PDP) and parts used together with image display devices, such as front face plates. Examples of the optical film that may be used include a polarizing film, a retardation film, an optical compensation film, a brightness enhancement film, a surface treatment film such as an anti-reflection film, and a laminate of any combination thereof.

### DESCRIPTION OF THE RELATED ART

Liquid crystal display devices, organic EL display devices, etc. have an image-forming mechanism including polarizing elements as essential components. For example, therefore, in a liquid crystal display device, polarizing elements are essentially placed on both sides of a liquid crystal cell, and generally, polarizing films are attached as the polarizing elements. Besides polarizing films, various optical elements have been used in display panels such as liquid crystal panels and organic EL panels for improving display quality. Front face plates are also used to protect image display devices such as liquid crystal display devices, organic EL display devices, CRTs, and PDPs or to provide a high-grade appearance or a differentiated design. Examples of parts used in image display devices such as liquid crystal display devices and organic EL display devices or parts used together with image display devices, such as front face plates, include retardation films for preventing discoloration, viewing angle-widening films for improving the viewing angle of liquid crystal displays, brightness enhancement films for increasing the contrast of displays, and surface treatment films such as hard-coat films for use in imparting scratch resistance to surfaces, antiglare treatment films for preventing glare on image display devices, and anti-reflection films such as anti-reflective films and low-reflective films. These films are generically called optical films.

When such optical films are bonded to a display panel such as a liquid crystal cell or an organic EL panel or bonded to a front face plate, a pressure-sensitive adhesive is generally used. In the process of bonding an optical film to a display panel such as a liquid crystal cell or an organic EL panel or to a front face plate or bonding optical films together, a pressure-sensitive adhesive is generally used to bond the materials together so that optical loss can be reduced. In such a case, a pressure-sensitive adhesive layer-attached optical film including an optical film and a pressure-sensitive adhesive layer previously formed on one side of the optical film is generally used, because it has some advantages such as no need for a drying process to fix the optical film.

As image display applications such as televisions, monitors, car navigation systems, and cellular phones have expanded, the pressure-sensitive adhesive layer-attached optical film has been required to have high durability under various environmental conditions (no decomposition or degradation of transparent protective films or no change in polarization properties in the case of polarizing films), such as durability with no change in optical properties even in cases where it is allowed to stand for a long time in a high-temperature and/or high-humidity environment and durability with no occurrence of appearance defects such as foaming or peeling of the pressure-sensitive adhesive layer. In particular, because of an increase in the size, high brightness, or high definition of liquid crystal displays, the demand for the improvement of the appearance of the pressure-sensitive adhesive layer-attached optical film has become stronger than ever.

Known methods for preventing the decomposition or degradation of the transparent protective film include a method of producing a pressure-sensitive adhesive with a smaller amount of acrylic acid (Patent Document 1) and a method of adding a tertiary amine to a pressure-sensitive adhesive (Patent Document 2). Unfortunately, these methods cannot prevent the change in the polarization properties of polarizing films or the foaming or peeling of a pressure-sensitive adhesive layer.

Traditionally, solvent-type pressure-sensitive adhesives are used to form pressure-sensitive adhesive layers for pressure-sensitive adhesive layer-attached optical films. Recently, however, a reduction in the use of organic solvents has been required in view of environmental loading, and solvent-type pressure-sensitive adhesives need to be replaced with water-dispersible pressure-sensitive adhesives, which are produced with water as a dispersion medium and without any organic solvent. For example, it is proposed that in a pressure-sensitive adhesive layer-attached optical film having a pressure-sensitive adhesive layer with a thickness of 5 μm to 50 μm made from a water-dispersible pressure-sensitive adhesive, the amount of ammonia derived from the pressure-sensitive adhesive layer should be controlled to 10 ng or more, and the total amount of ammonia in 1 cm² of the a pressure-sensitive adhesive layer-attached optical film should be controlled to 10 ng to 2,000 ng, so that the change in the polarization properties of a polarizing film used as an optical film can be reduced (Patent Document 3).

### PRIOR ART DOCUMENTS

### Patent Documents

Patent Document 1: JP-A-59-111114
Patent Document 2: JP-A-04-254803
Patent Document 3: JP-A-2007-248485

### DISCLOSURE OF THE INVENTION

### Problems to be Solved by the Invention

Ammonia-containing water-dispersible pressure-sensitive adhesives generally contain an acid component so that the dispersion stability of the aqueous dispersion (e.g., emulsion particles) in a liquid state can be ensured. For example, in the case of a water-dispersible acryl-based pressure-sensitive adhesive, an acid component such as acrylic acid is used to form an acryl-based polymer as a base polymer. However, if the acid component exists as it is in the aqueous dispersion, the stability of the aqueous dispersion cannot be sufficiently maintained. Usually, therefore, the acid component is neutralized with an alkali such as ammonia so that the dispersion stability of the aqueous dispersion is maintained. Patent Document 3 discloses that in order to prevent a pressure-sensitive adhesive layer-attached optical film from having appearance defects such as streaks and unevenness, the measured amount of ammonia derived from the pressure-sensitive adhesive layer made from the water-dispersible pressure-sensitive adhesive should be controlled to 10 ng or more per 1 cm² of the pressure-sensitive adhesive layer-attached optical film, and that in order to allow the pressure-sensitive adhesive layer-attached optical film to have a high level of durability and other properties, the total amount of ammonia should be controlled to 2,000 ng or less.

In some cases, however, the change in the polarization properties of a polarizing film cannot be prevented by only satisfying the ammonia amount conditions disclosed in Patent Document 3. In particular, thinner polarizing films with a higher degree of polarization are recently used, and it has become impossible to achieve a satisfactory level of optical durability when such polarizing films are used in a high-temperature and/or high-humidity environment.

It is an object of the present invention to provide a pressure-sensitive adhesive layer-attached optical film which includes an optical film including a polarizing film with a high degree of polarization and a pressure-sensitive adhesive layer placed on the optical film and made from an ammonia-containing water-dispersible pressure-sensitive adhesive and whose optical properties are less changeable even in a high-temperature and/or high-humidity environment.

A further object of the present invention is to provide an image display device including the pressure-sensitive adhesive layer-attached optical film.

As a result of earnest studies to solve the above problems, the inventors have accomplished the present invention based on the finding that the pressure-sensitive adhesive layer-attached optical film etc., described below can solve the problems.

The present invention relates to a pressure-sensitive adhesive layer-attached optical film, including:

an optical film; and

a pressure-sensitive adhesive layer for an optical film placed on at least one side of the optical film and made from an ammonia-containing water-dispersible pressure-sensitive adhesive, wherein

the pressure-sensitive adhesive layer has an ammonia content, measured by attributing to the pressure-sensitive adhesive layer, of 10 to 500 μg per 1 g of the pressure-sensitive adhesive layer,

the pressure-sensitive adhesive layer shows a difference of 0 to 500 μg per 1 g of the pressure-sensitive adhesive layer in ammonia content before and after a heat durability test in which the pressure-sensitive adhesive layer is heated at 90° C. for 1,000 hours and also shows a difference of 0 to 500 μg per g of the pressure-sensitive adhesive layer in ammonia content before and after a heat and humidity durability test in which the pressure-sensitive adhesive layer is stored at 60° C. and 95% R.H. for 1,000 hours, and

the optical film includes a polarizing film with a degree of polarization of 99.99% or more.

In the pressure-sensitive adhesive layer-attached optical film, the water-dispersible pressure-sensitive adhesive is preferably a water-dispersible acryl-based pressure-sensitive adhesive. As the water-dispersible acryl-based pressure-sensitive adhesive, preferable contains a copolymer emulsion obtained by polymerizing a monomer component including an alkyl(meth)acrylate and an acidic group-containing monomer in the presence of an emulsifier, wherein the total amount of the acidic group-containing monomer and the emulsifier is from 0.1 to 7 parts by weight based on 100 parts by weight of the total of the all monomer component and the emulsifier.

The pressure-sensitive adhesive layer-attached optical film is preferably used for the polarizing film including a polarizer and a transparent protective film provided on at least one side of the polarizer, wherein the transparent protective film on at least one side has a thickness of 40 μm or less, and the pressure-sensitive adhesive layer is placed directly on the transparent protective film.

The pressure-sensitive adhesive layer-attached optical film is preferably used for the polarizing film including a polarizer, and the pressure-sensitive adhesive layer is provided directly on at least one side of the polarizer.

The present invention also relates to an image display device including at least one piece of the pressure-sensitive adhesive layer-attached optical film.

Patent Document 3 discloses that a pressure-sensitive adhesive layer is made from an ammonia-containing water-dispersible pressure-sensitive adhesive and that the ammonia content is controlled to 10 ng to 2,000 ng per 1 cm². In some cases, however, even when the ammonia content of the pressure-sensitive adhesive layer falls within this range, the pressure-sensitive adhesive layer with a relatively high ammonia content cannot yield a satisfactory result in an optical durability test performed in a high-temperature and/or high-humidity environment. For example, it has been found that when a polarizing film with a high degree of polarization is used as the optical film, the degree of polarization can decrease so that the optical properties can degrade. Particularly when the pressure-sensitive adhesive layer is thin and has a relatively high ammonia content per unit volume, the ammonia content can significantly change before and after a heat durability test and a heat and humidity durability test, so that the optical durability can degrade.

In the pressure-sensitive adhesive layer-attached optical film of the present invention, the ammonia content per 1 g of the pressure-sensitive adhesive layer is controlled to 10 to 500 μg/g, which means that the ammonia content of the pressure-sensitive adhesive layer is controlled in a specific range so that the ammonia content per unit volume will not be too high even when the pressure-sensitive adhesive layer is made thin. When the ammonia content of the pressure-sensitive adhesive layer is controlled in this manner, the difference between the original ammonia content of the pressure-sensitive adhesive layer as formed (the state after coating and drying) and the residual ammonia content of the pressure-sensitive adhesive layer after a heat durability test and a heat and humidity durability test can be controlled to a specific value or less. During an optical durability test, ammonia may evaporate or bleed out of the pressure-sensitive adhesive layer to damage a polarizer and reduce the degree of polarization, so that the optical properties may degrade. In the present invention, however, the pressure-sensitive adhesive layer is so designed that the change of the ammonia content of the pressure-sensitive adhesive layer before and after a heat durability test and a heat and humidity durability test can be controlled in the small range of 0 to 500 μg/g, which means that the degradation of the optical properties can be kept small even when a polarizing film with a high degree of polarization is used.

### MODE FOR CARRYING OUT THE INVENTION

In the pressure-sensitive adhesive layer-attached optical film of the present invention, the pressure-sensitive adhesive layer has an ammonia content of 10 to 500 μg/g (μg per 1 g of the pressure-sensitive adhesive layer) when the pressure-sensitive adhesive layer itself is measured. The ammonia content is preferably from 20 to 300 μg/g, more preferably from 50 to 200 μg/g. If the ammonia content is more than 500 μg/g, ammonia can evaporate or bleed out of the pressure-sensitive adhesive layer in a high-temperature and/or high-humidity environment to damage a polarizer and thus degrade the degree of polarization and optical properties. On the other hand, to reduce the ammonia content to less than 10 μg/g, it will be necessary to apply a large amount of drying heat, which will require drying at high temperature in a step of forming pressure-sensitive adhesive layers. In such a case, the pressure-sensitive adhesive layer can undergo yellowing to degrade the optical properties and lower the contrast, which is not preferred.

In the pressure-sensitive adhesive layer-attached optical film of the present invention, the pressure-sensitive adhesive layer also shows a difference of 0 to 500 μg/g (μg per 1 g of the pressure-sensitive adhesive layer) in ammonia content before and after a heat durability test in which the pressure-sensitive adhesive layer is heated at 90° C. for 1,000 hours. The pressure-sensitive adhesive layer also shows a difference of 0 to 500 μg/g (μg per 1 g of the pressure-sensitive adhesive layer) in ammonia content before and after a humidity durability test in which the pressure-sensitive adhesive layer is stored at 60° C. and 95% R. H. for 1,000 hours. The differences in ammonia content are preferably from 0 to 300 μg/g, more preferably from 0 to 200 μg/g. If the differences in ammonia content are more than 500 μg/g, ammonia can evaporate or bleed out of the pressure-sensitive adhesive layer and pass through a thin protective film to damage a polarizer and thus degrade the degree of polarization and optical properties. On the other hand, as the differences in ammonia content decreases, it becomes possible to prevent the degradation of the degree of polarization even under harsh conditions such as high-temperature conditions at 90° C. or high-humidity conditions at 60° C. and 95% R.H, which is advantageous.

In the present invention, the pressure-sensitive adhesive layer is made from an ammonia-containing water-dispersible pressure-sensitive adhesive.

The water-dispersible pressure-sensitive adhesive is an aqueous dispersion containing at least water and a base polymer dispersed therein. Usually, the aqueous dispersion to be used contains a base polymer dispersed in the presence of a surfactant. However, an aqueous dispersion containing a self-dispersible base polymer dispersed by itself in water may also be used. The base polymer generally contains an acidic group such as a carboxyl group, a phosphate group, or a sulfonate group. When the acidic group of the base polymer is neutralized with an alkaline material such as ammonia, the water-dispersible pressure-sensitive adhesive can be used in the form of a highly stable aqueous dispersion.

The base polymer in the aqueous dispersion may be a product obtained by emulsion polymerization of a monomer or monomers in the presence of an emulsifier or a product obtained by dispersion polymerization of a monomer or monomers in the presence of a surfactant.

The aqueous dispersion may also be produced by dispersing and emulsifying a base polymer in water in the presence of an emulsifier, in which the base polymer has been produced separately. The emulsifying method may be a method including uniformly dispersing and emulsifying a polymer and an emulsifier, which may or may not have previously been melted by heating, with water using a mixer, such as a pressure kneader, a colloid mill, or a high-speed stirring shaft, under high shear conditions, and then cooling the mixture in such a manner that the dispersed particles do not fuse or aggregate, so that a desired aqueous dispersion is obtained (high-pressure emulsification method); or a method including previously dissolving a polymer in an organic solvent such as benzene, toluene, or ethyl acetate, then adding the emulsifier and water to the solution, uniformly dispersing and emulsifying the mixture typically using a high-speed homogenizer under high shear conditions, and then removing the organic solvent by a heat treatment under reduced pressure or other methods to form a desired aqueous dispersion (solvent solution method).

The water-dispersible pressure-sensitive adhesive may be of any type such as a rubber-based pressure-sensitive adhesive, an acryl-based pressure-sensitive adhesive, a silicone-based pressure-sensitive adhesive, a polyurethane-based pressure-sensitive adhesive, a vinyl alkyl ether-based pressure-sensitive adhesive, a polyvinyl alcohol-based pressure-sensitive adhesive, a polyvinylpyrrolidone-based pressure-sensitive adhesive, a polyacrylamide-based pressure-sensitive adhesive, a cellulose-based pressure-sensitive adhesive, a polyester-based pressure-sensitive adhesive or a fluorine-based pressure-sensitive adhesive. The pressure-sensitive adhesive base polymer or the dispersing means is selected depending on the type of the pressure-sensitive adhesive.

Among the pressure-sensitive adhesives, a water-dispersible acryl-based pressure-sensitive adhesive is preferably used in the present invention, because it has a high level of optical transparency and weather resistance or heat resistance and exhibits appropriate wettability and pressure-sensitive adhesive properties such as appropriate cohesiveness and tackiness.

The water-dispersible acryl-based pressure-sensitive adhesive includes a (meth)acryl-based polymer as a base polymer. For example, such a (meth)acryl-based polymer can be obtained in the form of a copolymer emulsion by emulsion polymerization of a monomer component, which includes an alkyl(meth)acrylate as a principal monomer and an acidic group-containing monomer, in the presence of an emulsifier and a radical polymerization initiator. The total amount of the acidic group-containing monomer and the emulsifier is preferably from 0.1 to 7 parts by weight based on 100 parts by weight of the total of the all monomer component and the emulsifier. As used herein, the term “alkyl(meth)acrylate” means alkyl acrylate and/or alkyl methacrylate, and “(meth)” is used in the same meaning in the description. The acidic group of the acidic group-containing monomer may be a carboxyl group, a phosphate group, a sulfonate group, or the like.

It has been found that the degradation of optical properties in an optical durability test becomes more likely to occur as the residual ammonia content and the change in ammonia content during the durability test increase. It has also been found that the amount of the acidic group-containing monomer and the emulsifier used to form the copolymer emulsion in the water-dispersible acryl-based pressure-sensitive adhesive can influence the degradation of the optical properties. This is because not only ammonia but also an acid component can cause a polarizer to be degraded and discolored.

The polarizing film to be used is generally in the form of a laminate including a polarizer and a transparent protective film placed on at least one side of the polarizer. When the pressure-sensitive adhesive layer is placed on the polarizing film, it may be placed directly on a polarizer or directly on a thin transparent protective film with a thickness of 40 μm or less. Particularly in this case, the properties of the pressure-sensitive adhesive layer are more likely to influence the polarizer and cause the degradation of the optical properties. Recent demands for thinner polarizing films and cost reduction promote the development of thinner transparent protective films and the study of techniques for making polarizing films with no transparent protective film. Therefore, if the ammonia contents of a water-dispersible-type pressure-sensitive adhesive layer does not fall within an optimal range, optical properties will be more likely to degrade in an optical durability test.

It has been found that the degradation of the optical properties of a polarizer can be more effectively reduced when the total amount of the acidic group-containing monomer and the emulsifier is from 0.1 to 7 parts by weight based on 100 parts by weight of the total of the all monomer component and the emulsifier used to form the copolymer emulsion in the water-dispersible acryl-based pressure-sensitive adhesive. The total amount of the acidic group-containing monomer and the emulsifier is more preferably from 0.3 to 6 parts by weight, even more preferably from 0.5 to 5 parts by weight. When the total amount of the acidic group-containing monomer and the emulsifier is 7 parts by weight or less, the degradation of the optical properties of the polarizing film can be prevented. When the total amount is 0.1 parts by weight or more, the water-dispersible pressure-sensitive adhesive can have a satisfactory level of dispersion stability, and the aqueous dispersion can have high mechanical stability during feeding, stirring, discharging, and other processes and be prevented from aggregating or gelling.

In view of emulsion polymerization reactivity, the alkyl(meth)acrylate used to form. the (meth)acryl-based polymer preferably has a water solubility in a specific range, and an alkyl acrylate having an alkyl group of 1 to 18 carbon atoms is preferably used to form a major component, so that the glass transition temperature can be easily controlled. Examples of the alkyl(meth)acrylate include methyl(meth)acrylate, ethyl(meth)acrylate, propyl(meth)acrylate, n-butyl(meth)acrylate, tert-butyl(meth)acrylate, n-hexyl(meth)acrylate, cyclohexyl(meth)acrylate, 2-ethylhexyl(meth)acrylate, n-octyl(meth)acrylate, lauryl(meth)acrylate, tridecyl(meth)acrylate, stearyl(meth)acrylate, and other alkyl esters of (meth)acrylic acid. These may be used alone or in combination of two or more. Among these, an alkyl(meth)acrylate having an alkyl group of 3 to 9 carbon atoms is preferable, such as propyl(meth)acrylate, n-butyl(meth)acrylate, 2-ethylhexyl(meth)acrylate, or n-octyl(meth)acrylate. The content of the alkyl(meth)acrylate (s) in all monomer units is preferably from 60 to 99.9% by weight, more preferably from 70 to 99.9% by weight, even more preferably from 80 to 99.9% by weight, still more preferably from 80 to 99% by weight, and yet more preferably from 80 to 95% by weight.

In view of emulsion polymerization reactivity, the (meth)acryl-based polymer preferably has a water solubility in a specific range, and an alkyl methacrylate having an alkyl group of 1 to 18 carbon atoms may be used, so that the glass transition temperature can be easily controlled. Examples of the alkyl methacrylate include methyl methacrylate, ethyl methacrylate, propyl methacrylate, n-butyl methacrylate, tert-butyl methacrylate, n-hexyl methacrylate, cyclohexyl methacrylate, 2-ethylhexyl methacrylate, n-octyl methacrylate, lauryl methacrylate, tridecyl methacrylate, stearyl methacrylate, isobornyl methacrylate, and other alkyl esters of methacrylic acid. These may be used alone or in combination of two or more. Among these, methyl methacrylate, ethyl methacrylate, and cyclohexyl methacrylate are preferred. The content of the alkyl methacrylate (s) in all monomer units is preferably from 39.9% by weight or less, more preferably 30% by weight or less, even more preferably 20% by weight or less, still more preferably 15% by weight or less.

To improve the tackiness of the pressure-sensitive adhesive and provide stability for the emulsion, a carboxyl group-containing monomer is used to form the (meth)acryl-based polymer. The carboxyl group-containing monomer may be monomer having a carboxyl group and a radically-polymerizable unsaturated double bond-containing group such as a (meth)acryloyl group or a vinyl group, examples of which include (meth)acrylic acid, itaconic acid, maleic acid, fumaric acid, crotonic acid, carboxyethyl acrylate, and carboxypentyl acrylate. The content of the carboxyl group-containing monomer in all monomer units of the (meth)acryl-based polymer is preferably from 0.1 to 10% by weight, more preferably from 0.5 to 7% by weight, and even more preferably from 1 to 5% by weight.

In addition to the alkyl(meth)acrylate and the carboxyl group-containing monomer, at least one copolymerizable monomer having an unsaturated double bond-containing polymerizable group such as a (meth)acryloyl group or a vinyl group may be introduced into the (meth)acryl-based polymer by copolymerization in order to stabilize water dispersibility, to improve adhesion to a base material such as an optical film for the pressure-sensitive adhesive layer, and to improve initial tackiness to the adherend.

An alkoxysilyl group-containing monomer is mentioned as the copolymerizable monomer. The alkoxysilyl group-containing monomer may be a silane coupling agent-type unsaturated monomer having an alkoxysilyl group and a group having at least one unsaturated double bond, such as a (meth)acryloyl group or a vinyl group. The alkoxysilyl group-containing monomer is preferred in order to allow the (meth)acryl-based polymer to have a crosslinked structure and improved adhesion to glass.

Examples of the alkoxysilyl group-containing monomer include an alkoxysilyl group-containing (meth)acrylate monomer and an alkoxysilyl group-containing vinyl monomer. Examples of the alkoxysilyl group-containing (meth)acrylate monomer include (meth)acryloyloxyalkyl-trialkoxysilanes such as (meth)acryloyloxymethyl-trimethoxysilane, (meth)acryloyloxymethyl-triethoxysilane, 2-(meth)acryloyloxyethyl-trimethoxysilane, 2-(meth)acryloyloxyethyl-triethoxysilane, 3-(meth)acryloyloxypropyl-trimethoxysilane, 3-(meth)acryloyloxypropyl-triethoxysilane, 3-(meth)acryloyloxypropyl-tripropoxysilane, 3-(meth)acryloyloxypropyl-triisopropoxysilane, and 3-(meth)acryloyloxypropyl-tributoxysilane; (meth)acryloyloxyalkyl-alkyldialkoxysilanes such as (meth)acryloyloxymethyl-methyldimethoxysilane, (meth)acryloyloxymethyl-methyldiethoxysilane, 2-(meth)acryloyloxyethyl-methyldimethoxysilane, 2-(meth)acryloyloxyethyl-methyldiethoxysilane, 3-(meth)acryloyloxypropyl-methyldimethoxysilane, 3-(meth)acryloyloxypropyl-methyldiethoxysilane, 3-(meth)acryloyloxypropyl-methyldipropoxysilane, 3-(meth)acryloyloxypropyl-methyldiisopropoxysilane, 3-(meth)acryloyloxypropyl-methyldibutoxysilane, 3-(meth)acryloyloxypropyl-ethyldimethoxysilane, 3-(meth)acryloyloxypropyl-ethyldiethoxysilane, 3-(meth)acryloyloxypropyl-ethyldipropoxysilane, 3-(meth)acryloyloxypropyl-ethyldiisopropoxysilane, 3-(meth)acryloyloxypropyl-ethyldibutoxysilane, 3-(meth)acryloyloxypropyl-propyldimethoxysilane, and 3-(meth)acryloyloxypropyl-propyldiethoxysilane; and (meth)acryloyloxyalkyl-dialkyl(mono)alkoxysilanes corresponding to these monomers. For example, alkoxysilyl group-containing vinyl monomers include vinyltrialkoxysilanes such as vinyltrimethoxysilane, vinyltriethoxysilane, vinyltripropoxysilane, vinyltriisopropoxysilane, and vinyltributoxysilane, and vinylalkyldialkoxysilanes and vinyldialkylalkoxysilanes corresponding thereto; vinylalkyltrialkoxysilanes such as vinylmethyltrimethoxysilane, vinylmethyltriethoxysilane, β-vinylethyltrimethoxysilane, β-vinylethyltriethoxysilane, γ-vinylpropyltrimethoxysilane, γ-vinylpropyltriethoxysilane, γ-vinylpropyltripropoxysilane, γ-vinylpropyltriisopropoxysilane, and γ-vinylpropyltributoxysilane, and (vinylalkyl)alkyldialkoxysilanes and (vinylalkyl)dialkyl(mono)alkoxysilanes corresponding thereto.

When the alkoxysilyl group-containing monomer is included in the (meth)acryl-based polymer, the content of the alkoxysilyl group-containing monomer in all monomer units of the (meth)acryl-based polymer is preferably from 0.001 to 1% by weight, more preferably from 0.01 to 0.5% by weight, and even more preferably from 0.03 to 0.1% by weight. If it is less than 0.001% by weight, the effect of using the alkoxysilyl group-containing monomer (providing a crosslinked structure and adhesion to glass) may be insufficiently obtained. If it is more than 1% by weight, the pressure-sensitive adhesive layer may have a too high degree of crosslinkage, so that the pressure-sensitive adhesive layer may crack over time.

The copolymerizable monomer may be a phosphate group-containing monomer. The phosphate group-containing monomer is effective in improving adhesion to glass.

For example, the phosphate group-containing monomer may be a phosphate group-containing monomer represented by formula (1) below or a salt thereof.

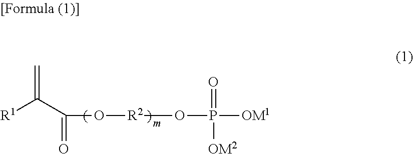

In formula (1), R¹ represents a hydrogen atom or a methyl group, R² represents an alkylene group of 1 to 4 carbon atoms, m represents an integer of 2 or more, and M¹ and M² each independently represent a hydrogen atom or a cation.

In formula (1), m is 2 or more, preferably 4 or more, generally 40 or less, and m represents the degree of polymerization of the oxyalkylene groups. The polyoxyalkylene group may be a polyoxyethylene group or a polyoxypropylene group, and these polyoxyalkylene groups may comprise random, block, or graft units. The cation of the salt of the phosphate group is typically, but not limited to, an inorganic cation such as an alkali metal such as sodium or potassium or an alkaline-earth metal such as calcium or magnesium, or an organic cation such as a quaternary amine.

When the phosphate group-containing monomer is included in the (meth)acryl-based polymer, the content of the phosphate group-containing monomer in all monomer units of the (meth)acryl-based polymer is preferably from 0.1 to 20% by weight. If it is less than 0.1% by weight, the effect of using the phosphate group-containing monomer (suppression of the formation of linear bubbles) may be insufficiently obtained, while a content of more than 20% by weight is not preferable in view of polymerization stability or pressure-sensitive adhesive properties.

Examples of copolymerizable monomers other than the alkoxysilyl group-containing monomer and the phosphate group-containing monomer include acid anhydride group-containing monomers such as maleic anhydride and itaconic anhydride; aryl(meth)acrylate such as phenyl(meth)acrylate; vinyl esters such as vinyl acetate and vinyl propionate; styrene monomers such as styrene; epoxy group-containing monomers such as glycidyl(meth)acrylate and methylglycidyl(meth)acrylate; hydroxyl group-containing monomers such as 2-hydroxyethyl(meth)acrylate and 2-hydroxypropyl(meth)acrylate; nitrogen atom-containing monomers such as (meth)acrylamide, N,N-dimethyl(meth)acrylamide, N,N-diethyl(meth)acrylamide, N-isopropyl(meth)acrylamide, N-butyl(meth)acrylamide, N-methylol(meth)acrylamide, N-methylolpropane(meth)acrylamide, (meth)acryloylmorpholine, aminoethyl(meth)acrylate, N,N-dimethylaminoethyl(meth)acrylate, and tert-butylaminoethyl(meth)acrylate; alkoxy group-containing monomers such as methoxyethyl(meth)acrylate and ethoxyethyl(meth)acrylate; cyano group-containing monomers such as acrylonitrile and methacrylonitrile; functional monomers such as 2-methacryloyloxyethyl isocyanate; olefin monomers such as ethylene, propylene, isoprene, butadiene, and isobutylene; vinyl ether monomers such as vinyl ether; halogen atom-containing monomers such as vinyl chloride; and other monomers including vinyl group-containing heterocyclic compounds such as N-vinylpyrrolidone, N-(1-methylvinyl)pyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, and N-vinylmorpholine, and N-vinylcarboxylic acid amides.

Examples of the copolymerizable monomer also include maleimide monomers such as N-cyclohexylmaleimide, N-isopropylmaleimide, N-laurylmaleimide, and N-phenylmaleimide; itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide; succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide; and sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl(meth)acrylate, and (meth)acryloyloxynaphthalenesulfonic acid.

Examples of the copolymerizable monomer also include glycol acrylate monomers such as polyethylene glycol(meth)acrylate, polypropylene glycol(meth)acrylate, methoxyethylene glycol(meth)acrylate, and methoxypolypropylene glycol(meth)acrylate; and other monomers such as acrylic ester monomers containing a heterocyclic ring or a halogen atom, such as tetrahydrofurfuryl(meth)acrylate and fluoro(meth)acrylate.

A polyfunctional monomer, other than the above alkoxysilyl group-containing monomer, may also be used as the copolymerizable monomer for a purpose such as control of the gel fraction of the water-dispersible pressure-sensitive adhesive. The polyfunctional monomer may be a compound having two or more unsaturated double bonds such as those in (meth)acryloyl groups or vinyl groups. Examples that may also be used include (meth)acrylate esters of polyhydric alcohols, such as (mono or poly)alkylene glycol di(meth)acrylates including (mono or poly)ethylene glycol di(meth)acrylates such as ethylene glycol di(meth)acrylate, diethylene glycol di(meth)acrylate, triethylene glycol di(meth)acrylate, trimethylolpropane tri(meth)acrylate, and tetraethylene glycol di(meth)acrylate, (mono or poly)propylene glycol di(meth)acrylate such as propylene glycol di(meth)acrylate, neopentyl glycol di(meth)acrylate, 1,6-hexanediol di(meth)acrylate, pentaerythritol di(meth)acrylate, trimethylolpropane tri(meth)acrylate, pentaerythritol tri(meth)acrylate, and dipentaerythritol hexa(meth)acrylate; polyfunctional vinyl compounds such as divinylbenzene; diacetone acrylamide; and compounds having two or more reactive unsaturated double bonds which have different reactivity respectively, such as allyl(meth)acrylate and vinyl(meth)acrylate. The polyfunctional monomer may also be a compound having a polyester, epoxy or urethane skeleton to which two or more unsaturated double bonds are added in the form of functional groups such as (meth)acryloyl groups or vinyl groups in the same manner as the monomer component, such as polyester(meth)acrylate, epoxy(meth)acrylate, or urethane(meth)acrylate.

When a monofunctional monomer is used as the copolymerizable monomer other than the alkoxysilyl group-containing monomer and the phosphate group-containing monomer, the content of the copolymerizable monomer in all monomer units of the (meth)acryl-based polymer is preferably 20% by weight or less, more preferably 10% by weight or less, and even more preferably 5% by weight or less in view of the stability of the emulsion and prevention of an excessive increase in the viscosity of the emulsion. When a polyfunctional monomer is used as the copolymerizable monomer, the content of the copolymerizable monomer in all monomer units of the (meth)acryl-based polymer is preferably 5% by weight or less, more preferably 3% by weight or less, and even more preferably 1% by weight or less in view of the stability of the emulsion.

An aqueous dispersion of the (meth)acryl-based polymer can be obtained by polymerizing a monomer component including an alkyl(meth)acrylate and a carboxyl group-containing monomer in the presence of a surfactant and a radial polymerization initiator. The polymerization means may be emulsion polymerization, suspension polymerization, or dispersion polymerization. The emulsion polymerization, the suspension polymerization, and the dispersion polymerization produce a polymer emulsion, a polymer suspension, and a polymer dispersion, respectively. The type of the pressure-sensitive adhesive polymer and the means for polymerization are selected depending on the type of the pressure-sensitive adhesive. The surfactant, which may be an emulsifying agent in the case of emulsion polymerization or a dispersing gent in the case of suspension polymerization, is appropriately selected depending on each polymerization means.

In the present invention, the aqueous dispersion for the water-dispersible pressure-sensitive adhesive is preferably an emulsion-type pressure-sensitive adhesive produced using a polymer emulsion obtained by emulsion polymerization.

According to a conventional technique, the monomer component may be emulsified in water and then subjected to emulsion polymerization. An aqueous dispersion containing a (meth)acryl-based polymer as a base polymer (a polymer emulsion) is prepared by this method. In the emulsion polymerization, for example, the surfactant (emulsifying agent), a radical polymerization initiator, and an optional additive such as a chain transfer agent are appropriately added to the monomer component. More specifically, for example, a known emulsion polymerization method may be employed, such as a batch mixing method (batch polymerization method), a monomer dropping method, or a monomer emulsion dropping method. In the monomer dropping method, continuous dropping or divided dropping is appropriately selected. These methods may be appropriately combined. While reaction conditions and so on may be appropriately selected, for example, the polymerization temperature is preferably from about 40 to about 95° C., and the polymerization time is preferably from about 30 minutes to about 24 hours.

The surfactant (emulsifying agent) for use in the emulsion polymerization may be, but not limited to, any of various surfactants commonly used in emulsion polymerization. As the surfactant, an anionic or a nonionic surfactant is generally used. Examples of the anionic surfactant include higher fatty acid salts such as sodium oleate; alkylarylsulfonate salts such as sodium dodecylbenzenesulfonate; alkylsulfate ester salts such as sodium laurylsulfate and ammonium laurylsulfate; polyoxyethylene alkyl ether sulfate ester salts such as sodium polyoxyethylene lauryl ether sulfate; polyoxyethylene alkyl aryl ether sulfate ester salts such as sodium polyoxyethylene nonyl phenyl ether sulfate; alkyl sulfosuccinic acid ester salts such as sodium monooctyl sulfosuccinate, sodium dioctyl sulfosuccinate, and sodium polyoxyethylene lauryl sulfosuccinate, and derivatives thereof; polyoxyethylene distyrenated phenyl ether sulfate ester salts; and sodium naphthalenesulfonate-formalin condensate. Examples of the nonionic surfactant include polyoxyethylene alkyl ethers such as polyoxyethylene lauryl ether and polyoxyethylene stearyl ether; polyoxyethylene alkyl phenyl ethers such as polyoxyethylene octyl phenyl ether and polyoxyethylene nonyl phenyl ether; sorbitan higher fatty acid esters such as sorbitan monolaurate, sorbitan monostearate, and sorbitan trioleate; polyoxyethylene sorbitan higher fatty acid esters such as polyoxyethylene sorbitan monolaurate; polyoxyethylene higher fatty acid esters such as polyoxyethylene monolaurate and polyoxyethylene monostearate; glycerin higher fatty acid esters such as oleic acid monoglyceride and stearic acid monoglyceride; and polyoxyethylene-polyoxypropylene block copolymers, and polyoxyethylene distyrenated phenyl ether.

Besides the above non-reactive surfactants, a reactive surfactant having a radical-polymerizable functional group containing an ethylenic unsaturated double bond may be used as the surfactant. The reactive surfactant may be a radical-polymerizable surfactant prepared by introducing a radical-polymerizable functional group (radically reactive group) such as a propenyl group or an allyl ether group into the anionic surfactant or the nonionic surfactant. These surfactants may be appropriately used alone or in any combination. Among these surfactants, the radical-polymerizable surfactant having a radical-polymerizable functional group is preferably used in view of the stability of the aqueous dispersion or the durability of the pressure-sensitive adhesive layer.

Examples of anionic reactive surfactants include alkyl ether surfactants (examples of commercially available products include AQUALON KH-05, KH-10, and KH-20 manufactured by Dai-ichi Kogyo Seiyaku Co., Ltd., ADEKA REASOAP SR-10N and SR-20N manufactured by ADEKA CORPORATION, LATEMUL PD-104 manufactured by Kao Corporation, and others); sulfosuccinic acid ester surfactants (examples of commercially available products include LATEMUL S-120, S-120A, S-180P, and S-180A manufactured by Kao Corporation and ELEMINOL JS-2 manufactured by Sanyo Chemical Industries, Ltd., and others); alkyl phenyl ether surfactants or alkyl phenyl ester surfactants (examples of commercially available products include AQUALON H-2855A, H-3855B, H-3855C, H-3856, HS-05, HS-10, HS-20, HS-30, BC-05, BC-10, and BC-20 manufactured by Dai-ichi Kogyo Seiyaku Co., Ltd., and ADEKA REASOAP SDX-222, SDX-223, SDX-232, SDX-233, SDX-259, SE-10N, and SE-20N manufactured by ADEKA CORPORATION); (meth)acrylate sulfate ester surfactants (examples of commercially available products include ANTOX MS-60 and MS-2N manufactured by Nippon Nyukazai Co., Ltd., ELEMINOL RS-30 manufactured by Sanyo Chemical Industries Co., Ltd., and others); and phosphoric acid ester surfactants (examples of commercially available products include H-3330PL manufactured by Dai-ichi Kogyo Seiyaku Co., Ltd. ADEKA REASOAP PP-70 manufactured by ADEKA CORPORATION, and others). Examples of nonionic reactive surfactants include alkyl ether surfactants (examples of commercially available products include ADEKA REASOAP ER-10, ER-20, ER-30, and ER-40 manufactured by ADEKA CORPORATION, LATEMUL PD-420, PD-430, and PD-450 manufactured by Kao Corporation, and others); alkyl phenyl ether surfactants or alkyl phenyl ester surfactants (examples of commercially available products include AQUALON RN-10, RN-20, RN-30, and RN-50 manufactured by Dai-ichi Kogyo Seiyaku Co., Ltd., ADEKA REASOAP NE-10, NE-20, NE-30, and NE-40 manufactured by ADEKA CORPORATION, and others); and (meth)acrylate sulfate ester surfactants (examples of commercially available products include RMA-564, RMA-568, and RMA-1114 manufactured by Nippon Nyukazai Co., Ltd, and others).

The content of the surfactant is preferably from 0.3 to 5 parts by weight based on 100 parts by weight of the monomer components including the alkyl(meth)acrylate. Pressure-sensitive adhesive properties, polymerization stability, mechanical stability, etc. can be improved by controlling the content of the surfactant. The surfactant content is more preferably from 0.3 to 4 parts by weight.

The radical polymerization initiator may be, but not limited to, any known radical polymerization initiator commonly used in emulsion polymerization. Examples include azo initiators such as 2,2′-azobisisobutylonitrile, 2,2′-azobis(2-methylpropionamidine)disulfate, 2,2′-azobis(2-methylpropionamidine)dihydrochloride, 2,2′-azobis(2-amidinopropane)dihydrochloride, and 2,2′-azobis[2-(2-imidazoline-2-yl)propane]dihydrochloride; persulfate initiators such as potassium persulfate and ammonium persulfate; peroxide initiators such as benzoyl peroxide, tert-butyl hydroperoxide, and hydrogen peroxide; substituted ethane initiators such as phenyl-substituted ethane; and carbonyl initiators such as aromatic carbonyl compounds. These polymerization initiators may be appropriately used alone or in any combination. If desired, the emulsion polymerization may be performed using a redox system initiator, in which a reducing agent is used in combination with the polymerization initiator. This makes it easy to accelerate the emulsion polymerization rate or to perform the emulsion polymerization at low temperature. Examples of such a reducing agent include reducing organic compounds such as ascorbic acid, erythorbic acid, tartaric acid, citric acid, glucose, and metal salts of formaldehyde sulfoxylate or the like; reducing inorganic compounds such as sodium thiosulfate, sodium sulfite, sodium bisulfite, and sodium metabisulfite; and ferrous chloride, Rongalite, and thiourea dioxide.

The content of the radical polymerization initiator is typically from about 0.02 to about 1 part by weight, preferably from 0.02 to 0.5 parts by weight, more preferably from 0.08 to 0.3 parts by weight, based on 100 parts by weight of the monomer components, while it is appropriately selected. If it is less than 0.02 parts by weight, the radical polymerization initiator may be less effective. If it is more than 1 part by weight, the (meth)acryl-based polymer in the aqueous dispersion (polymer emulsion) may have a reduced molecular weight, so that the water-dispersible pressure-sensitive adhesive may have reduced durability. In the case of a redox system initiator, the reducing agent is preferably used in an amount of 0.01 to 1 part by weight based on 100 parts by weight of the total amount of the monomer components.

A chain transfer agent is optionally used to control the molecular weight of the (meth)acryl-based polymer. In general, chain transfer agents commonly used in emulsion polymerization are used. Examples include 1-dodecanthiol, mercaptoacetic acid, 2-mercaptoethanol, 2-ethylhexyl thioglycolate, 2,3-dimercapto-1-propanol, mercaptopropionic acid esters, and other mercaptans. These chain transfer agents may be appropriately used alone or in any combination. For example, the content of the chain transfer agent is from 0.001 to 0.3 parts by weight based on 100 parts by weight of the monomer components.

Such emulsion polymerization makes it possible to prepare the (meth)acryl-based copolymer in the form of an aqueous dispersion (emulsion). The average particle size of such an water-dispersible (meth)acryl-based copolymer is typically adjusted to 0.05 μm to 3 μm, and preferably to 0.05 μm to 1 μm. If the average particle size is less than 0.05 μm, the viscosity of the water-dispersible pressure-sensitive adhesive can increase in some cases, and if it is more than 3 μm, adhesiveness between particles can decrease so that cohesive strength can decrease in some cases.

In general, the water-dispersible (meth)acryl-based polymer according to the present invention preferably has a weight average molecular weight of 1,000,000 or more. In particular, the weight average molecular weight is preferably from 1,000,000 to 4,000,000 in view of heat resistance or moisture resistance. A weight average molecular weight of less than 1,000,000 is not preferred, because with such a molecular weight, heat resistance or moisture resistance may decrease. The pressure-sensitive adhesive obtained by the emulsion polymerization is preferred because the polymerization mechanism can produce very high molecular weight. It should be noted, however, that the pressure-sensitive adhesive obtained by the emulsion polymerization generally has a high gel content and cannot be subjected to GPC (gel permeation chromatography) measurement, which means that it is often difficult to identify the molecular weight by actual measurement.

An acidic group such as a carboxyl group is introduced into the base polymer or the like so that stability can be imparted to the aqueous dispersion for the water-dispersible pressure-sensitive adhesive. Such a carboxyl group is neutralized before use. The neutralization is performed using at least ammonia. In addition, other alkaline materials may be used for the neutralization. Examples of other alkaline materials include alkali metal hydroxides such as sodium hydroxide, potassium hydroxide, magnesium hydroxide, and calcium hydroxide; and organic amine compounds such as monomethylamine, dimethylamine, trimethylamine, monoethylamine, diethylamine, triethylamine, monopropylamine, dipropylamine, monoethanolamine, diethanolamine, triethanolamine, N,N-dimethyl-ethanolamine, N,N-diethyl-ethanolamine, 2-dimethylamino-2-methyl-1-propanol, 2-amino-2-methyl-1-propanol, N-methyldiethanolamine, N-ethyldiethanolamine, monoisopropanolamine, diisopropanolamine, and triisopropanolamine. Such a non-ammonia alkaline material may be used so that the ratio (molar ratio) of ammonia to the non-ammonia alkaline material is from 100/0 to 1/99 when the molar fraction of the added alkaline materials is normalized as 100% by mole. To maintain the dispersion stability of the aqueous dispersion for the water-dispersible acryl-based pressure-sensitive adhesive, the (meth)acryl-based polymer in the aqueous dispersion contains a monomer unit derived from an acidic group-containing monomer such as a carboxyl group-containing monomer. In the (meth)acryl-based polymer, the monomer unit derived from an acidic group-containing monomer such as a carboxyl group-containing monomer is neutralized with ammonia.

Ammonia water can be used in the neutralization with ammonia. Ammonia water that is usually used is an aqueous solution with a concentration of 1 to 30%. The addition of ammonia water is controlled in such a way that the ammonia content per 1 g of the pressure-sensitive adhesive layer is from 10 to 500 μg/g. The amount of ammonia in the pressure-sensitive adhesive layer is properly controlled, taking into account the thickness of the pressure-sensitive adhesive layer and other factors.

In general, the ammonia water is preferably added to the water-dispersible pressure-sensitive adhesive in such a way that the water-dispersible pressure-sensitive adhesive contains about 0.05 to about 5 parts, more preferably 0.1 to 1 part by weight of ammonia, from the ammonia water, based on 100 parts by weight of the solid in the water-dispersible pressure-sensitive adhesive.

Besides the additives described above, the water-dispersible pressure-sensitive adhesive neutralized with ammonia water may contain known additives such a pH buffer, an antifoaming agent, and a stabilizer as needed.

The water-dispersible pressure-sensitive adhesive of the present invention may contain a crosslinking agent in addition to the base polymer. When the water-dispersible pressure-sensitive adhesive is an water-dispersible acryl-based pressure-sensitive adhesive, examples of the crosslinking agent that may be used include those commonly used, such as an isocyanate crosslinking agent, an epoxy crosslinking agent, an oxazoline crosslinking agent, an aziridine crosslinking agent, a carbodiimide crosslinking agent, and a metal chelate crosslinking agent. When a functional group-containing monomer is used, these crosslinking agents have the effect of reacting with the functional group incorporated in the polymer to form crosslinkage.

The content of the crosslinking agent (on solid basis) is generally, but not limited to, about 10 parts by weight or less based on 100 parts by weight of the base polymer (on solid basis). The content of the crosslinking agent is preferably from about 0.001 to about 10 parts by weight, more preferably from about 0.01 to about 5 parts by weight.

If necessary, the water-dispersible pressure-sensitive adhesive of the present invention may further appropriately contain any of various additives such as viscosity adjusting agent, releasing adjusting agent, tackifiers, plasticizers, softener, fillers including glass fibers, glass beads, metal power, or any other inorganic powder, pigments, colorants (pigments, dyes or the likes), pH adjusting agent (acid or base), antioxidants, and ultraviolet ray absorbing agents, silane coupling agents, without departing from the objects of the present invention. The water-dispersible pressure-sensitive adhesive may also contain fine particles to form a light-diffusing pressure-sensitive adhesive layer. These additives may also be added in the form of emulsion.

The water-dispersible pressure-sensitive adhesive of the present invention may have any solid concentration, and the solid concentration will not interfere with the effect of the present invention. In view of coating appearance, the solid concentration of the water-dispersible pressure-sensitive adhesive is preferably from 20 to 70% by weight, more preferably from 30 to 65% by weight, even more preferably from 37 to 55% by weight.

The pressure-sensitive adhesive layer for an optical film of the present invention is made from the water-dispersible pressure-sensitive adhesive. The pressure-sensitive adhesive layer can be formed by a process including applying the water-dispersible pressure-sensitive adhesive to a substrate (an optical film or a release film) and then drying the pressure-sensitive adhesive.

The pressure-sensitive adhesive layer-attached optical film of the present invention includes an optical film and the pressure-sensitive adhesive layer or layers placed on one or both sides of the optical film. The pressure-sensitive adhesive layer-attached optical film of the present invention can be formed by a process including applying the water-dispersible pressure-sensitive adhesive to an optical film or a release film and drying the water-dispersible pressure-sensitive adhesive. When the pressure-sensitive adhesive layer is formed on a release film, the pressure-sensitive adhesive layer will be transferred and bonded to an optical film.

Various methods may be used in the applying step of the water-dispersible pressure-sensitive adhesive. Examples include roll coating, kiss roll coating, gravure coating, reverse coating, roll brush coating, spray coating, dip roll coating, bar coating, knife coating, air knife coating, curtain coating, lip coating, and extrusion coating using a die coater or the like.

In the applying step, the amount of the application should be controlled so that a pressure-sensitive adhesive layer with a predetermined thickness (post-drying thickness) can be formed. The thickness (post-drying thickness) of the pressure-sensitive adhesive layer is generally set within the range of about 1 μm to about 200 μm, preferably within the range of 3 μm to 100 μm, more preferably within the range of 5 μm to 50 μm, and more preferably within the range of 7 μm to 30 μm.

The applied water-dispersible pressure-sensitive adhesive is then dried to form the pressure-sensitive adhesive layer. The drying temperature or the drying time may be controlled to adjust the ammonia content of the pressure-sensitive adhesive layer. The ammonia content of the pressure-sensitive adhesive layer can be reduced by raising the drying temperature or increasing the drying time. The drying temperature is preferably from 80° C. to 200° C., more preferably from 100° C. to 180° C., even more preferably from 130° C. to 160° C. The drying time is preferably from 0.5 to 10 minutes, more preferably from 1 to 5 minutes. When the drying conditions are set, the drying temperature is preferably set at 130° C. or higher, and the drying time is preferably set at 1 minute or more. It will be understood, however, that even when low temperature conditions with a drying temperature of less than 130° C. are used, the ammonia content can be reduced by using a longer drying time.

Examples of the material used to form the release film include a plastic film such as a polyethylene, polypropylene, polyethylene terephthalate, or polyester film, a porous material such as paper, fabric, or nonwoven fabric, and an appropriate thin material such as a net, a foamed sheet, a metal foil, and a laminate thereof. A plastic film is preferably used, because of its good surface smoothness.

Any plastic film capable of protecting the pressure-sensitive adhesive layer may be used, examples of which include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the release film is generally from about 5 to about 200 μm, preferably from about 5 to about 100 μm. If necessary, the separator may be subjected to a release treatment and an antifouling treatment with a silicone, fluoride, long-chain alkyl, or fatty acid amide release agent, silica powder or the like, or subjected to an antistatic treatment of coating type, kneading and mixing type, vapor-deposition type, or the like. In particular, when the surface of the release film is appropriately subjected to a release treatment such as a silicone treatment, a long-chain alkyl treatment, or a fluorine treatment, the releasability from the pressure-sensitive adhesive layer can be further increased.

The pressure-sensitive adhesive layer may be exposed. In such a case, the pressure-sensitive adhesive layer may be protected by the release film until it is actually used. The release film may be used as is as a separator for a pressure-sensitive adhesive layer-attached optical film, so that the process can be simplified.

An optical film may also be coated with an anchor layer or subjected to any adhesion-facilitating treatment such as a corona treatment or a plasma treatment so as to have improved adhesion to a pressure-sensitive adhesive layer, and then the pressure-sensitive adhesive layer may be formed. The surface of the pressure-sensitive adhesive layer may also be subjected to an adhesion-facilitating treatment.

Materials that may be used to form the anchor layer preferably include an anchoring agent selected from polyurethane, polyester, polymers containing an amino group in the molecule, and polymers containing an oxazolinyl group in the molecule, in particular, preferably polymers containing an amino group in the molecule and polymers containing an oxazolinyl group in the molecule. Polymers containing an amino group in the molecule and polymers containing an oxazolinyl group in the molecule allow the amino group in the molecule or an oxazolinyl group in the molecule to react with a carboxyl group or the like in the pressure-sensitive adhesive or to make an interaction such as an ionic interaction, so that good adhesion can be ensured.

Examples of polymers containing an amino group in the molecule include polyethyleneimine, polyallylamine, polyvinylamine, polyvinylpyridine, polyvinylpyrrolidine, and a polymer of an amino group-containing monomer such as dimethylaminoethyl acrylate.

The optical film is, but not limited to the kinds, used for forming image display device such as liquid crystal display. A polarizing film is exemplified. A polarizing film including a polarizer and a transparent protective film provided on one side or both sides of the polarizer is generally used.

A polarizer is, but not limited to, various kinds of polarizer may be used. As a polarizer, for example, a film that is uniaxially stretched after having dichromatic substances, such as iodine and dichromatic dye, absorbed to hydrophilic polymer films, such as polyvinyl alcohol-based film, partially formalized polyvinyl alcohol-based film, and ethylene-vinyl acetate copolymer-based partially saponified film; polyene-based alignment films, such as dehydrated polyvinyl alcohol and dehydrochlorinated polyvinyl chloride, etc. may be mentioned. In these, a polyvinyl alcohol-based film on which dichromatic materials such as iodine, is absorbed and aligned after stretched is suitably used. Thickness of polarizer is, but not limited to, generally about 1 μm about 80 μm.

A polarizer that is uniaxially stretched after a polyvinyl alcohol-based film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol-based film may be dipped in water and rinsed if needed. By rinsing polyvinyl alcohol-based film with water, effect of preventing un-uniformity, such as unevenness of dyeing, is expected by making polyvinyl alcohol-based film swelled in addition that also soils and blocking inhibitors on the polyvinyl alcohol-based film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

A thermoplastic resin with a high level of transparency, mechanical strength, thermal stability, moisture blocking properties, isotropy, and the like may be used as a material for forming the transparent protective film. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic olefin polymer resins (norbornene resins), polyarylate resins, polystyrene resins, polyvinyl alcohol resins, and any mixture thereof. The transparent protective film is generally laminated to one side of the polarizer with the adhesive layer, but thermosetting resins or ultraviolet curing resins such as (meth)acrylic, urethane, acrylic urethane, epoxy, or silicone resins may be used to other side of the polarizer for the transparent protective film. The transparent protective film may also contain at least one type of any appropriate additive. Examples of the additive include an ultraviolet absorbing agent, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, still more preferably from 60 to 98% by weight, particularly preferably from 70 to 97% by weight. If the content of the thermoplastic resin in the transparent protective film is 50% by weight or less, high transparency and other properties inherent in the thermoplastic resin can fail to be sufficiently exhibited.

The thickness of the transparent protective film may be determined as appropriate. The transparent protective film generally has a thickness of about 1 to about 500 μm in view of strength, workability such as handleability, thin layer formability, or other properties. In particular, the thickness of the transparent protective film is preferably from 1 to 300 μm, more preferably from 5 to 200 μm. The pressure-sensitive adhesive layer according to the present invention is particularly advantageous when the pressure-sensitive adhesive layer is formed directly on a thin transparent protective film with a thickness of 40 μm or less.

An optical film may be exemplified as other optical layers, such as a reflective plate, a transflective plate, a retardation film (a half wavelength plate and a quarter wavelength plate included), a viewing angle compensation film, a brightness enhancement film, a surface treatment film or the like, which may be used for formation of a liquid crystal display etc. These are used in practice as an optical film, or as one layer or two layers or more of optical layers laminated with polarizing film.

Although an optical film with the above described optical layer laminated to the polarizing film may be formed by a method in which laminating is separately carried out sequentially in manufacturing process of a liquid crystal display device or the like, an optical film in a form of being laminated beforehand has an outstanding advantage that it has excellent stability in quality and assembly workability, and thus manufacturing processes ability of a liquid crystal display device or the like may be raised. Proper adhesion means, such as a pressure-sensitive adhesive layer, may be used for laminating. On the occasion of adhesion of the above described polarizing film and other optical films, the optical axis may be set as a suitable configuration angle according to the target retardation characteristics or the like.

The surface treatment film may also be provided on and bonded to a front face plate. Examples of the surface treatment film include a hard-coat film for use in imparting scratch resistance to the surface, an antiglare treatment film for preventing glare on image display devices, and an anti-reflection film such as an anti-reflective film or a low-reflective film, etc. The front face plate is provided on and bonded to the surface of an image display device such as a liquid crystal display device, an organic EL display device, a CRT, or a PDP to protect the image display device or to provide a high-grade appearance or a differentiated design. The front faceplate is also used as a support for a A/4 plate in a 3D-TV. In a liquid crystal display device, for example, the front face plate is provided above a polarizing film on the viewer side. When the pressure-sensitive adhesive layer according to the present invention is used, the same effect can be produced using a plastic base material such as a polycarbonate or poly(methyl methacrylate) base material for the front face plate, as well as using a glass base material.

The pressure-sensitive adhesive layer-attached optical film of the present invention is preferably used to form various types of image display devices such as liquid crystal display devices. Liquid crystal display devices may be produced according to conventional techniques. Specifically, liquid crystal display devices are generally produced by appropriately assembling a display panel such as a liquid crystal cell and the pressure-sensitive adhesive layer-attached optical film and optionally other components such as a lighting system and incorporating a driving circuit according to any conventional technique, except that the pressure-sensitive adhesive layer-attached optical film of the present invention is used. Any type of liquid crystal cell may also be used such as a TN type, an STN type, a n type, a VA type and an IPS type.

Suitable liquid crystal display devices, such as liquid crystal display device with which the above pressure-sensitive adhesive layer-attached optical film has been provided on one side or both sides of the display panel such as a liquid crystal cell, and with which a backlight or a reflective plate is used for a lighting system may be manufactured. In this case, the optical film of the present invention may be provided on one side or both sides of the display panel such as a liquid crystal cell. When providing the optical films on both sides, they may be of the same type or of different type. Furthermore, in assembling a liquid crystal display device, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro luminescence equipment (organic EL display device: OLED) will be explained. Generally, in organic EL display device, a transparent electrode, an organic luminescence layer and a metal electrode are laminated on a transparent substrate in an order configuring an illuminant (organic electro luminescence illuminant). Here, an organic luminescence layer is a laminated material of various organic thin films, and much compositions with various combination are known, for example, a laminated material of hole injection layer comprising triphenylamine derivatives etc., a luminescence layer comprising fluorescent organic solids, such as anthracene; a laminated material of electronic injection layer comprising such a luminescence layer and perylene derivatives, etc.; laminated material of these hole injection layers, luminescence layer, and electronic injection layer etc.

An organic EL display device emits light based on a principle that positive hole and electron are injected into an organic luminescence layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in an intermediate process is the same as a mechanism in common diodes, and, as is expected, there is a strong non-linear relationship between electric current and luminescence strength accompanied by rectification nature to applied voltage.

In an organic EL display device, in order to take out luminescence in an organic luminescence layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg—Ag and Al—Li, are usually used.

In organic EL display device of such a configuration, an organic luminescence layer is formed by a very thin film about 10 nm in thickness. For this reason, light is transmitted nearly completely through organic luminescence layer as through transparent electrode. Consequently, since the light that enters, when light is not emitted, as incident light from a surface of a transparent substrate and is transmitted through a transparent electrode and an organic luminescence layer and then is reflected by a metal electrode, appears in front surface side of the transparent substrate again, a display side of the organic EL display device looks like mirror if viewed from outside.

In an organic EL display device containing an organic electro luminescence illuminant equipped with a transparent electrode on a surface side of an organic luminescence layer that emits light by impression of voltage, and at the same time equipped with a metal electrode on a back side of organic luminescence layer, a retardation film may be installed between these transparent electrodes and a polarizing film, while preparing the polarizing film on the surface side of the transparent electrode.

Since the retardation film and the polarizing film have function polarizing the light that has entered as incident light from outside and has been reflected by the metal electrode, they have an effect of making the mirror surface of metal electrode not visible from outside by the polarization action. If a retardation film is configured with a quarter wavelength plate and the angle between the two polarization directions of the polarizing film and the retardation film is adjusted to n/4, the mirror surface of the metal electrode may be completely covered.

This means that only linearly polarized light component of the external light that enters as incident light into this organic EL display device is transmitted with the work of polarizing film. This linearly polarized light generally gives an elliptically polarized light by the retardation film, and especially the retardation film is a quarter wavelength plate, and moreover when the angle between the two polarization directions of the polarizing film and the retardation film is adjusted to n/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation film. And since this linearly polarized light lies at right angles to the polarization direction of the polarizing film, it cannot be transmitted through the polarizing film. As the result, mirror surface of the metal electrode may be completely covered.

As described above, in order to block mirror reflection, the organic EL panel of an organic EL display device may use an elliptically or circularly polarizing film having a combination of a retardation film and a polarizing film with the pressure-sensitive adhesive layer interposed therebetween. Alternatively, without an elliptically or circularly polarizing film directly bonded to an organic EL panel, a laminate formed by bonding an elliptically or circularly polarizing film to a touch panel with the pressure-sensitive adhesive layer interposed therebetween may be used in an organic EL panel.

The present invention is applicable to various types of touch panel, such as optical, ultrasonic, capacitance, and resistive touch panels. A resistive touch panel includes: a touch-side, touch panel-forming electrode plate having a transparent conductive thin film; and a display device-side, touch panel-forming electrode plate having a transparent conductive thin film, wherein the electrode plates are opposed to each other with spacers interposed therebetween in such a manner that the transparent conductive thin films are opposed to each other. A capacitance touch panel generally includes a transparent conductive film that has a transparent conductive thin film in a specific pattern and is formed over the surface of a display device unit. The pressure-sensitive adhesive layer-attached optical film according to the present invention may be used on any of the touch side and the display device side.

### EXAMPLES

Hereinafter, the present invention is more specifically described with reference to the examples, which however are not intended to limit the present invention. In each example, “parts” and “%” are all by weight.

### <Preparation of Polarizing Film (1)>

An 80-μm-thick polyvinyl alcohol film was stretched to 3 times between rollers different in velocity ratio, while it was dyed in a 0.3% iodine solution at 30° C. for 1 minute. The film was then stretched to a total stretch ratio of 6 times, while it was immersed in an aqueous solution containing 4% boric acid and 10% potassium iodide at 60° C. for 0.5 minutes. Subsequently, the film was washed by immersion in an aqueous solution containing 1.5% potassium iodide at 30° C. for 10 seconds, and then dried at 50° C. for 4 minutes to give a polarizer. An 40-μm-thick saponified triacetylcellulose film was bonded to one side of the polarizer with a polyvinyl alcohol-based adhesive. A 25-μm-thick cyclic olefin-based resin film (ARTON (trade name) manufactured by JSR Corporation) was bonded to the other side of the polarizer with a polyvinyl alcohol-based adhesive, so that a polarizing film (1) was obtained. The resulting polarizing film (1) had a degree of polarization of 99.9996.

### <Preparation of Polarizing Film (2)>

An 80-μm-thick polyvinyl alcohol film was stretched to 3 times between rollers different in velocity ratio, while it was dyed in a 0.3% iodine solution at 30° C. for 1 minute. The film was then stretched to a total stretch ratio of 6 times, while it was immersed in an aqueous solution containing 4% boric acid and 10% potassium iodide at 60° C. for 0.5 minutes. Subsequently, the film was washed by immersion in an aqueous solution containing 1.5% potassium iodide at 30° C. for 10 seconds, and then dried at 50° C. for 4 minutes to give a polarizer. A 25-μm-thick cyclic olefin-based resin film (ARTON (trade name) manufactured by JSR Corporation) was bonded to one side of the polarizer with a polyvinyl alcohol-based adhesive, so that a polarizing film (2), which is one side protected-type, was obtained. The resulting polarizing film (2) had a degree of polarization of 99.9985.

### Example 1

### Preparation of Emulsion-Type Pressure-Sensitive Adhesive

To a vessel were added 100 parts of methyl methacrylate (MMA), 880 parts of butyl acrylate (BA), and 20 parts of acrylic acid (AA) and mixed to form a vinyl monomer mixture. To 200 parts of the vinyl monomer mixture (A) prepared with the above composition were then added 8 parts of AQUALON HS-10 (manufactured by DAI-ICHI KOGYO SEIYAKU CO., LTD.) as an emulsifier and 127 parts of ion-exchanged water. The resulting mixture was forcedly emulsified by stirring at 6,000 (rpm) for 5 minutes with a homo mixer (manufactured by PRIMIX Corporation) to form a monomer pre-emulsion (A-1).

To another vessel were added 800 parts of the vinyl monomer mixture (A), 24 parts of AQUALON HS-10 (manufactured by DAI-ICHI KOGYO SEIYAKU CO., LTD.) as an emulsifier, and 382 parts of ion-exchanged water. The resulting mixture was forcedly emulsified by stirring at 6,000 (rpm) for 5 minutes with a homo mixer (manufactured by PRIMIX Corporation) to form a monomer pre-emulsion (A-2).

A reaction vessel equipped with a condenser tube, a nitrogen introducing tube, a thermometer, and a stirrer was charged with 335 parts of the monomer pre-emulsion (A-1) and 655 parts of ion-exchanged water. Subsequently, the air in the reaction vessel was replaced with nitrogen gas, and 1.0 g of ammonium persulfate (APS, manufactured by Kishida Chemical Co., Ltd.) was added to the reaction vessel. The mixture was subjected to polymerization at 60° C. for 1 hour with stirring. Subsequently, 1,206 parts of the monomer pre-emulsion (A-2) was added dropwise over 3 hours to the reaction vessel being kept at 60° C. The mixture was then subjected to polymerization for 3 hours to form an aqueous dispersion with a solid content of 46.0% containing a water-dispersible polymer. The product was then cooled to room temperature, and 19 parts of 10% ammonia water as an alkaline material was added thereto to adjust pH to 8, so that an emulsion was obtained. The emulsion had a non-volatile content of 45.2%. The content of acrylic acid as an acidic group-containing monomer, the content of AQUALON HS-10 as an emulsifier, and the total content thereof are 1.9%, 3.1%, and 5%, respectively, based on the amount of the emulsion-type pressure-sensitive adhesive (the total amount of all the monomers and the emulsifier).

### (Formation of Pressure-Sensitive Adhesive Layer and Preparation of Pressure-Sensitive Adhesive Layer-Attached Polarizing Film)

The emulsion-type acryl-based pressure-sensitive adhesive obtained in the above was applied to a release film (Diafoil MRF-38, manufactured by Mitsubishi Chemical Polyester Co., Ltd., a polyethylene terephthalate backing) with a die coater so that a 25-μm-thick coating could be formed after drying, and then the coating was dried at 160° C. for 3 minutes to form a pressure-sensitive adhesive layer. The pressure-sensitive adhesive layer was bonded to each of two different polarizing films (1) and (2), so that two different pressure-sensitive adhesive layer-attached polarizing films (1) and (2) were obtained. When the polarizing film (1) was used, the pressure-sensitive adhesive layer was bonded to the 25-μm-thick cyclic olefin-based resin film side of the polarizing film (1). When the polarizing film (2) was used, the pressure-sensitive adhesive layer was bonded to the polarizer side of the polarizing film (2). The release film was used, as is, as a separator.

### Examples 2 to 4 and Comparative Examples 1 to 6

Pressure-sensitive adhesive layers were formed as in Example 1, except that the drying conditions (the temperature and the time) were changed as shown in Table 1. Each resulting pressure-sensitive adhesive was bonded to each of the polarizing films (1) and (2) as in Example 1, so that pressure-sensitive adhesive layer-attached polarizing films (1) and (2) were obtained.

### Example 5

A pressure-sensitive adhesive layer-attached polarizing film was prepared as in Example 1, except that 100 parts of methyl methacrylate (MMA), 830 parts of butyl acrylate (BA), 50 parts of acrylic acid (AA), and 20 parts of mono[poly(propylene oxide) methacrylate]phosphate ester (5.0 in average degree of polymerization of propylene oxide) was used to form the vinyl monomer mixture in the preparation of the emulsion-type pressure-sensitive adhesive. The content of acrylic acid as an acidic group-containing monomer, the content of mono[poly(propylene oxide) methacrylate]phosphate ester, the content of AQUALON FIS-10 as an emulsifier, and the total content thereof are 4.8%, 1.9%, 3.1%, and 9.8%, respectively, based on the amount of the emulsion-type pressure-sensitive adhesive (the total amount of all the monomers and the emulsifier).

### Example 6 and Comparative Examples 7 to 8

Pressure-sensitive adhesive layers were formed as in Example 5, except that the drying conditions (the temperature and the time) were changed as shown in Table 1. Each resulting pressure-sensitive adhesive was bonded to each of the polarizing films (1) and (2) as in Example 1, so that pressure-sensitive adhesive layer-attached polarizing films (1) and (2) were obtained.

The pressure-sensitive adhesive layer-attached polarizing films (1) and (2) obtained in each of the examples and the comparative examples were evaluated as described below. The results are shown in Table 1.

### <Measurement of Ammonia Content>

The separator accompanying and pressure-sensitive adhesive layer-attached polarizing films (1) and (2) were each cut into a piece of 10 cm×10 cm. Only the pressure-sensitive adhesive layer was taken out of the piece and then subjected to boiling and extraction in pure water at 120° C. for 1 hour. The resulting liquid extract was subjected to the quantification of ammonium ions using ion chromatogram (DX-500 manufactured by Dionex Corporation). Five samples were measured, and the average of the measurements was calculated and used as the ammonia content (μg/g). The average was then converted into a value per 1 cm², which is also shown as the ammonia content (ng/cm²). Both the pressure-sensitive adhesive layer-attached polarizing films (1) and (2) had the same ammonia content.

### <<Humidity Durability Test>>

The separator accompanying and pressure-sensitive adhesive layer-attached polarizing films (1) and (2) were each cut into sample pieces of 6 cm×4 cm. The resulting 300 sample pieces were placed in a 200 ml glass bottle, so that the glass bottle was filled with the polarizing films. The glass bottle filled with the sample pieces was stored in an environment at 60° C. and 95% R.H. for 10 minutes so that the temperature and humidity of the environment inside the glass bottle became 60° C. and 95% R.H., respectively. The glass bottle was then capped. The cap was further sealed with a sealing tape so that the gas was kept from leaking out of the interior of the glass bottle. The glass bottle was then stored in an environment at 60° C. and 95% R.H. for 1,000 hours.

### <<Heat Durability Test>>

Sample pieces were prepared as in the humidity durability test. The resulting 300 sample pieces were placed in a 200 ml glass bottle, so that the glass bottle was filled with the polarizing films. The glass bottle was capped after the glass bottle was filled with the sample pieces. The cap was further sealed with a sealing tape so that the gas was kept from leaking out of the interior of the glass bottle. The glass bottle was then stored in an environment at 90° C. for 1,000 hours.

### <Change of Ammonia Content>

After each of the humidity durability test and the heat durability test, the sample pieces were taken out of the glass bottle and then subjected to the measurement of the ammonia content of the pressure-sensitive adhesive layer using the same measurement method as described above. The difference between the ammonia contents measured before and after each of the humidity durability test and the heat durability test was calculated and used as the change (μg/g) of ammonia content. Both the pressure-sensitive adhesive layer-attached polarizing films (1) and (2) were the same in the ammonia content value.

### <Amount of Change of Degree of Polarization>

The separator accompanying and pressure-sensitive adhesive layer-attached polarizing films (1) and (2) were subjected to the humidity durability test and the heat durability test. Before and after each durability test, the degree of polarization of the pressure-sensitive adhesive layer-attached polarizing films (1) and (2) was measured using the method described below. The absolute value A of the amount (P1a−P2a) of change of the degree of polarization of the pressure-sensitive adhesive layer-attached polarizing films (1) and (2) was calculated from the degree (P1a) of polarization before the durability test and the degree (P2a) of polarization after the durability test.

On the other hand, the polarizing films (1) and (2) having no pressure-sensitive adhesive layer bonded thereto were also subjected to the humidity durability test and the heat durability test. Before and after each durability test, the degree of polarization of the polarizing films (1) and (2) was measured using the method described below. The absolute value B of the amount (P1b−P2b) of change of the degree of polarization of the polarizing films (1) and (2) was calculated from the degree (P1b) of polarization before the durability test and the degree (P2b) of polarization after the durability test.

Table 1 shows the value (B−A) calculated by subtracting the absolute value A from the absolute value B. The value (B−A) was used to measure the effect of the ammonia content of the pressure-sensitive adhesive layer. The value (B−A) that is amount of change of the degree of polarization, which is calculated by subtracting the absolute value A from the absolute value B, is preferably 1% or less, more preferably 0.2% or less.

### <<Measurement of Degree of Polarization>>

The degree of polarization of the polarizing film or the separator accompanying and pressure-sensitive adhesive layer-attached polarizing film was measured. The separator was peeled off from the separator and accompanying and pressure-sensitive adhesive layer-attached polarizing film before the degree of polarization was measured. The degree of polarization was measured using an integrating sphere-equipped spectrophotometer (V7100 manufactured by JASCO Corporation). The degree of polarization is calculated from the formula below using the minimum transmittance (K₂) and the maximum transmittance (K₁). The minimum transmittance (K₂) was measured when the transmission axis of the polarizing film or the pressure-sensitive adhesive layer-attached polarizing film was placed orthogonal to the plane of vibration of the polarized light from the prism. The maximum transmittance (K₁) was measured when the polarizing film or the pressure-sensitive adhesive layer-attached polarizing film was rotated by 90 degrees.

Degree (%) of polarization={(K₂−K₁)/(K₂+K₁)}×100.

Each transmittance was expressed as the Y value, which was obtained through luminosity correction using the two-degree field (illuminant C) according to JIS Z 8701 when the transmittance for completely polarized light obtained through a Glan-Taylor prism polarizer was normalized as 100%.

TABLE 1

| | Conditions for drying | | | | | |
|---|---|---|---|---|---|---|
| | pressure-sensitive | | Pressure-sensitive adhesive layer | | | |
| | adhesive layer | | Thickness of | Total content (%) | Ammonia content | |
| | Drying | | pressure-sensitive | of acidic-group | Ammonia | Ammonia |
| | temperature | Drying time | adhesive layer | containing monomer | content | content |
| | (° C.) | (minutes) | (μm) | and emulsifier | (ng/cm²) | (μg/g) |
| Example 1 | 160 | 3 | 25 | 5 | 300 | 120 |
| Example 2 | 150 | 3 | 25 | 5 | 1200 | 480 |
| Example 3 | 155 | 3 | 25 | 5 | 800 | 320 |
| Example 4 | 140 | 3 | 25 | 5 | 980 | 480 |
| Example 5 | 140 | 3 | 25 | 9.8 | 1250 | 500 |
| Example 6 | 140 | 3 | 25 | 9.8 | 1125 | 450 |
| Comparative | 120 | 2 | 25 | 5 | 2800 | 1120 |
| Example 1 | | | | | | |
| Comparative | 120 | 1 | 25 | 5 | 4125 | 1850 |
| Example 2 | | | | | | |
| Comparative | 60 | 3 | 25 | 5 | 10750 | 4300 |
| Example 3 | | | | | | |
| Comparative | 80 | 3 | 25 | 5 | 6250 | 2500 |
| Example 4 | | | | | | |
| Comparative | 120 | 3 | 25 | 5 | 1700 | 680 |
| Example 5 | | | | | | |
| Comparative | 120 | 2.5 | 25 | 5 | 2000 | 800 |
| Example 6 | | | | | | |
| Comparative | 130 | 0.5 | 25 | 9.8 | 4000 | 1600 |
| Example 7 | | | | | | |
| Comparative | 120 | 2 | 25 | 9.8 | 1875 | 750 |
| Example 8 | | | | | | |

| | Pressure-sensitive | | | | | |
|---|---|---|---|---|---|---|
| | adhesive layer | | Evaluations | | | |
| | Ammonia content | | Polarizing film (1) | | Polarizing film (2) | |
| | Content change | | Change (%) of degree | | Change (%) of degree | |
| | (μg/g) before and | | of polarization before | | of polarization before | |
| | after durability test | | and after durability test | | and after durability test | |
| | | 60° C. and | | 60° C. and | | 60° C. and |
| | 90° C. for | 95% R.H. for | 90° C. for | 95% R.H. for | 90° C. for | 95% R.H. for |
| | 1,000 hours | 1,000 hours | 1,000 hours | 1,000 hours | 1,000 hours | 1,000 hours |
| Example 1 | 60 | 20 | 0.01 | 0.01 | 0.01 | 0.21 |
| Example 2 | 350 | 150 | 0.05 | 0.07 | 0.06 | 0.34 |
| Example 3 | 220 | 100 | 0.03 | 0.05 | 0.04 | 0.29 |
| Example 4 | 420 | 210 | 0.07 | 0.10 | 0.10 | 0.45 |
| Example 5 | 440 | 250 | 0.12 | 0.23 | 0.21 | 0.98 |
| Example 6 | 390 | 200 | 0.11 | 0.20 | 0.18 | 0.87 |
| Comparative | 930 | 670 | 1.23 | 3.31 | 2.51 | 4.11 |
| Example 1 | | | | | | |
| Comparative | 1430 | 980 | 3.25 | 8.54 | 6.54 | 11.63 |
| Example 2 | | | | | | |
| Comparative | 3830 | 2310 | 67.91 | 94.28 | 78.31 | 99.43 |
| Example 3 | | | | | | |
| Comparative | 2380 | 1570 | 45.68 | 88.83 | 62.59 | 92.95 |
| Example 4 | | | | | | |
| Comparative | 620 | 520 | 0.81 | 1.46 | 1.21 | 3.31 |
| Example 5 | | | | | | |
| Comparative | 750 | 630 | 1.15 | 2.11 | 1.65 | 4.97 |
| Example 6 | | | | | | |
| Comparative | 1340 | 1020 | 4.32 | 6.62 | 4.41 | 7.65 |
| Example 7 | | | | | | |
| Comparative | 720 | 680 | 1.02 | 1.67 | 1.91 | 4.35 |
| Example 8 | | | | | | |

Table 1 shows that in the examples where the ammonia content per 1 g of the pressure-sensitive adhesive layer was controlled, a satisfactory level of optical durability was attained when a polarizing film with a high degree of polarization was used.

1. A pressure-sensitive adhesive layer-attached optical film, comprising:
an optical film; and
a pressure-sensitive adhesive layer for an optical film placed on at least one side of the optical film and made from an ammonia-containing water-dispersible pressure-sensitive adhesive, wherein
the pressure-sensitive adhesive layer has an ammonia content, measured by attributing to the pressure-sensitive adhesive layer, of 10 to 500 μg per 1 g of the pressure-sensitive adhesive layer,
the pressure-sensitive adhesive layer shows a difference of 0 to 500 μg per 1 g of the pressure-sensitive adhesive layer in ammonia content before and after a heat durability test in which the pressure-sensitive adhesive layer is heated at 90° C. for 1,000 hours and also shows a difference of 0 to 500 μg per g of the pressure-sensitive adhesive layer in ammonia content before and after a heat and humidity durability test in which the pressure-sensitive adhesive layer is stored at 60° C. and 95% R.H. for 1,000 hours, and
the optical film includes a polarizing film with a degree of polarization of 99.99% or more.

2. The pressure-sensitive adhesive layer-attached optical film according to claim 1, wherein the water-dispersible pressure-sensitive adhesive is a water-dispersible acryl-based pressure-sensitive adhesive.

3. The pressure-sensitive adhesive layer-attached optical film according to claim 2, wherein the water-dispersible acryl-based pressure-sensitive adhesive contains a copolymer emulsion obtained by polymerizing a monomer component including an alkyl(meth)acrylate and an acidic group-containing monomer in the presence of an emulsifier, wherein the total amount of the acidic group-containing monomer and the emulsifier is from 0.1 to 7 parts by weight based on 100 parts by weight of the total of the all monomer component and the emulsifier.

4. The pressure-sensitive adhesive layer-attached optical film according to claim 1, wherein the polarizing film comprises a polarizer and a transparent protective film provided on at least one side of the polarizer, wherein the transparent protective film on at least one side has a thickness of 40 μm or less, and the pressure-sensitive adhesive layer is placed directly on the transparent protective film.

5. The pressure-sensitive adhesive layer-attached optical film according to claim 1, wherein the polarizing film comprises a polarizer, and the pressure-sensitive adhesive layer is provided directly on at least one side of the polarizer.

6. An image display device comprising at least one piece of the pressure-sensitive adhesive layer-attached optical film according to claim 1.
